(19) United States
(12) Patent Application Publication
(10) Pub. No.: US 2014/0127646 A1
(43) Pub. Date: May 8, 2014

(54) COLOR SELECTOR DEVICE

(71) Applicant: The Valspar Corporation, (US)

(72) Inventors: Gretchen L. Schauffler, Lake Oswego, OR (US); Joel R. Wasserman, Buffalo Grove, IL (US)

(73) Assignee: THE VALSPAR CORPORATION, Minneapolis, MN (US)

(21) Appl. No.: 13/667,957

(22) Filed: Nov. 2, 2012

(51) Int. Cl. G09B 11/04

(52) U.S. Cl. CPC G09B 11/04
USPC 434/81; 427/280

(57) ABSTRACT

A paint or stain color selection device includes a frame sized for arms-length handheld use. The frame at least partially surrounds a viewing aperture. A plurality of distinct paint or stain color representations having surface areas smaller than the cross-sectional area defined by the viewing aperture are disposed on the frame and distributed around the viewing aperture. The device may be held in a user's hand and used to view remote objects or surfaces through the viewing aperture while visually comparing the object or surface to one or more of the paint or stain color representations.

### FIELD

This invention relates to devices for choosing paint and stain colors.

### BACKGROUND

Architectural paint and stain manufacturers typically distribute premixed paints and stains in a small number of popular colors. Consumers generally prefer a much wider color palette, in order better to match existing painted or stained surfaces, or to select appropriate complementary or contrasting colors for use on nearby surfaces. To accommodate such consumers, manufacturers typically also distribute a set of tintable base paints or stains and several concentrated colorants. These are combined at point-of-sale outlets using colorant dispensing and shaker mixing equipment to make small batch lots of custom-tinted paint or stain in a much larger array of colors than the limited color array available in premixed products.

To assist in color selection, manufacturers and merchants sometimes provide color selection tools such as small (e.g., 25 to 50 mm wide by 150 to 250 mm long) color cards containing printed or other representations of available colors, fan decks containing a stack of color cards on a pivot axis, or large (e.g., 200 to 220 mm wide by 250-300 mm long) single color pages or sheets designed to be held against a wall or other surface. Other color selection tools include trial size liquid paint or stain samples that enable a consumer to apply a custom color paint or stain at a home or other job site, and computer-based (e.g., browser-based or smart phone app-based) software tools that enable a consumer to simulate the appearance of a custom color paint or stain using a display and in some instances a camera.

Despite the variety of available color selection tools, color selection can still be time-consuming and difficult. Some manufacturers offer thousands of custom tints, and choosing from amongst the many available choices can overwhelm or frustrate some consumers.

From the foregoing, it will be appreciated that what is needed in the art are improved color selection tools that may be easier or faster to use and that may assist a consumer in choosing a desired color. Such color selection tools and methods for their manufacture and use are disclosed and claimed herein.

### SUMMARY OF THE INVENTION

The present invention provides, in one aspect, a paint or stain color selection device comprising a frame sized for arms-length handheld use, the frame having first and second major surfaces, at least one interiorly-disposed edge portion, and at least one exteriorly-disposed edge portion; the frame at least partially surrounding a viewing aperture defined by the interiorly-disposed edge portion(s); and the frame having disposed on at least one of the major surfaces and distributed around the viewing aperture a plurality of distinct paint or stain color representations having surface areas smaller than the cross-sectional area defined by the viewing aperture.

The invention provides, in another aspect, an array of such color selection devices collectively representing paints or stains in a plurality of hues and tints.

The invention provides, in yet another aspect, a method for making a paint color selection device, the method comprising:
a) providing a frame sized for arms-length handheld use, the frame having first and second major surfaces and at least one exteriorly-disposed edge portion; the frame at least partially surrounding an actual or openable viewing aperture; and
b) applying to a major surface of the frame a plurality of distinct paint or stain color representations having surface areas smaller than the cross-sectional area defined by the viewing aperture, the paint or stain color representations being distributed around the viewing aperture.

The invention provides, in yet another aspect, a method for selecting a paint or stain, the method comprising:
a) providing a paint or stain color selection device comprising a frame sized for arms-length handheld use, the frame having first and second major surfaces, at least one interiorly-disposed edge portion, and at least one exteriorly-disposed edge portion; the frame at least partially surrounding a viewing aperture defined by the interiorly-disposed edge portion(s); and the frame having disposed on at least one of the major surfaces and distributed around the viewing aperture a plurality of distinct paint or stain color representations having surface areas smaller than the cross-sectional area defined by the viewing aperture;
b) selecting a viewable object or surface for comparison to the paint or stain color representations;
c) viewing the object or surface through the viewing aperture while visually comparing the object or surface to one or more of the paint or stain color representations.

The disclosed devices and methods facilitate selection and comparison of paint and stain colors, tints and surface reflectivities.

### BRIEF DESCRIPTION OF THE DRAWING

FIG. 1 is a plan view of an exemplary color selection device;

FIG. 2 is a side view of the FIG. 1 device;

FIG. 3 is a perspective view of a user employing the FIG. 1 device to make a paint color selection;

FIG. 4 through FIG. 7 are plan views of exemplary additional color selection devices; and

FIG. 8 and FIG. 9 are plan views of two exemplary color selection device arrays.

Like reference symbols in the various figures of the drawing indicate like elements. The elements in the drawing are not to scale.

### DETAILED DESCRIPTION

The recitation of a numerical range using endpoints includes all numbers subsumed within that range (e.g., 1 to 5 includes 1, 1.5, 2, 2.75, 3, 3.80, 4, 5, etc.).

The terms “a,” “an,” “the,” “at least one,” and “one or more” are used interchangeably. Thus, for example, a color selection device described as having “an” interiorly-disposed edge portion has “one or more” such edge portions.

The terms “architectural paints” and “architectural stains” respectively mean paints and stains for use on interior or exterior building components.

The term “binder” means a film-forming natural or synthetic polymer suitable for use in a paint or stain.

The term “colorant” means a composition that may be added to a base paint or stain so as to alter the hue or lightness of such base paint or stain, and which contains pigment or dye and an optional vehicle but is substantially free of binder.

The term “colored” when used with respect to a paint, stain, pigment or colorant means having a color other than white, e.g., having a hue such as red, green, blue or yellow. Black paints, stains, pigments and colorants will also be deemed to be colored for purposes of the present disclosure.

The term “custom-tinted” when used with respect to paints or stains means that one or more colorants can be dispensed into a base paint or stain and mixed to provide finished paint or stains in a wide variety (e.g., more than one hundred or even more than one thousand) of preselected formulated colors or, if desired, a match for randomly-selected colors.

The term “distinct” when used with respect to a plurality of paint or stain color representations on a frame of a color selection device means that the paint or stain color representations are not all the same color, not all the same surface reflectivity, or not all the same color and surface reflectivity.

The term “opaque” when used in respect to a dry coating film means that the film has a contrast ratio greater than 95%. The contrast ratio may be determined by casting a 25 μm dry thickness coating film over the black and white parts of a BYK-Gardner No. PA-2811 opacity drawdown chart (from BYK-Gardner USA), measuring L* as defined in the ASTM International Standards on Color and Appearance Measurement: 8th Edition, and dividing the L* value measured over the black portion by the L* value measured over the white portion.

The term “paint” means a coating composition including pigment and binder which when applied to form a thin (e.g., 100 μm) wet thickness coating film on a freshly-sanded smooth wood surface, will when dried form an opaque dried or cured film that hides both the wood grain and its texture and presents a new surface with its own appearance.

The term “pigment” includes not only particulate pigments that function by reflecting light but also soluble or dispersible dyes that function by absorbing light.

The terms “polymer” and “polymeric” include polymers as well as copolymers of two or more monomers.

The terms “preferred” and “preferably” refer to embodiments of the invention that may afford certain benefits, under certain circumstances. However, other embodiments may also be preferred, under the same or other circumstances. Furthermore, the recitation of one or more preferred embodiments does not imply that other embodiments are not useful, and is not intended to exclude other embodiments from the scope of the invention.

The term “primer” refers to a coating composition that is applied in one or more layers to a bare substrate and which if left uncoated without a topcoat would not be capable of withstanding extended outdoor exposure (e.g., exposure equivalent to one year of vertical south-facing Florida sunlight) without visually objectionable deterioration.

The term “sized for arms-length handheld use” when used with respect to a color selection device having a frame and viewing aperture means that the device has a shape and dimensions (and preferably a stiffness) such that an average user can comfortably hold the device in an upright position in one outstretched hand while viewing a distant object or objects by peering through the viewing aperture. This does not mean that the device must be held at arms' length, but merely that it may comfortably be so held if desired.

The term “solvent-borne” when used in respect to a paint, stain or colorant means that the major liquid vehicle or carrier for the paint, stain or colorant is a nonaqueous solvent or mixture of nonaqueous solvents.

The term “stain” means a coating composition including binder which when applied to form a thin (e.g., 100 μm) wet thickness coating film on a freshly-sanded smooth wood surface, will when dried not hide both the wood grain and its texture. When a semi-transparent stain is applied to wood, the wood grain and its texture normally both remain noticeable, whereas when a solid color (viz., opaque) stain is applied the grain normally becomes hidden while the texture normally remains noticeable. A stain typically will soak into a wood or other porous substrate to a much greater extent than will a paint.

The term “topcoat” refers to a coating composition which when dried or otherwise hardened provides a decorative or protective outermost finish layer on a coated substrate. By way of further explanation, such topcoats may be applied in one or more layers and may be applied to bare or primer-coated substrates.

The term “water-borne” when used in respect to a paint, stain or colorant means that the major liquid vehicle or carrier for the paint, stain or colorant is water.

When discussing the various Drawing figures referred to below, the description will focus on paint color selection, it being understood that the disclosed devices can readily be used for stain selection with relatively minor modifications in the disclosed color representations and if need be in the disclosed frame. Thus any description of a drawing element as involving a paint will also be understood to describe a drawing element involving a stain.

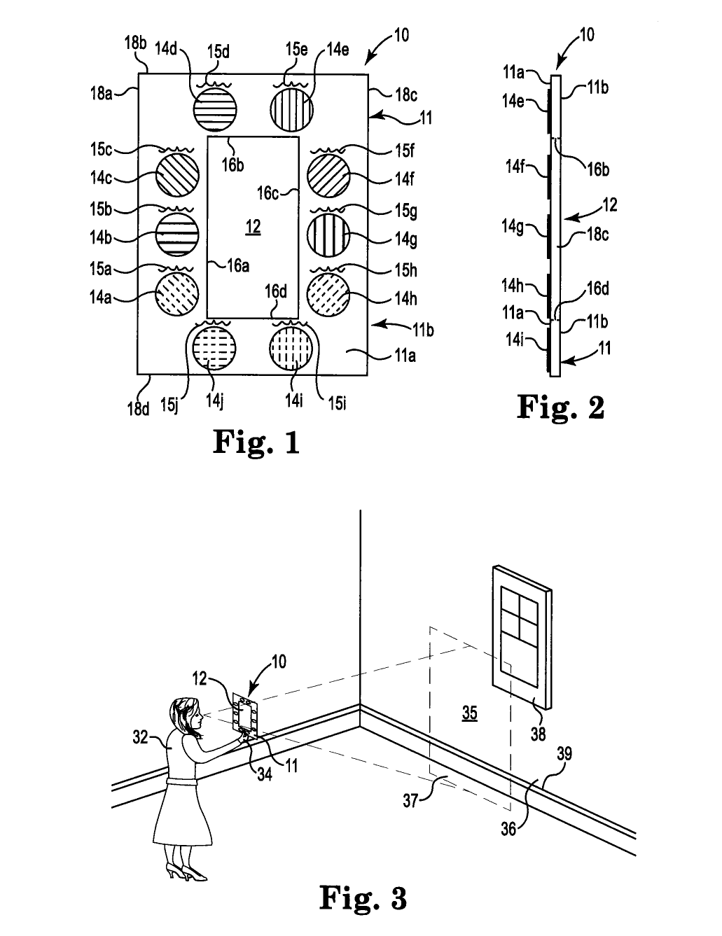

Referring to FIG. 1 and FIG. 2, paint color selection device 10 includes frame 11 having a visible first major surface or facing side 11a and a second major surface or reverse side 11b (not shown in FIG. 1) on the backside of frame 11. Viewing aperture 12 is surrounded by generally circular paint color representations 14a through 14j disposed on major surface 11a and distributed around viewing aperture 12. Interiorly-disposed edge portions 16a through 16d define the interior edge of frame 11 and the perimeter of viewing aperture 12. Exteriorly-disposed edge portions 18a through 18b define the outer edge or perimeter of frame 11. Paint color representations 14a through 14j have viewable surface areas smaller than the cross-sectional area defined by viewing aperture 12. Although not required for successful use of device 10, the total (viz., aggregate) surface area of frame 11 occupied by paint color representations 14a through 14j in the FIG. 1 device is also smaller than the cross-sectional area defined by viewing aperture 12. Device 10 also includes paint identifying labels or other indicia 15a through 15j which in the embodiment shown in FIG. 1 are placed above each corresponding paint color representation. Other placements may be employed if desired, including placement of all indicia towards the outside of the frame (viz., between the paint color representations and the outer frame perimeter), towards the inside of the frame (viz., between the paint color representations and the viewing aperture), on the paint color representations (e.g., using a suitable contrasting color ink) or on second major surface 11b. In the interest of simplifying the remaining figures of the Drawing, paint identifying indicia have not been included in the embodiments shown in FIG. 3 through FIG. 9, discussed below.

In the device shown in FIG. 1, frame 11 and viewing aperture 12 are both rectangular, and the paint color representations 14a through 14j are approximately circular. Each may independently have another shape or shapes. For example, frame and viewing aperture may have different shapes, and the paint color representations need not all have the same shape. Thus a wide variety of shapes may be employed for the frame, viewing aperture(s) and paint color representations, including squares, rectangles, trapezoids, rhombuses, triangles, ovals, circles, and irregular shapes that may only approximate these regular or geometric shapes. In addition, although the frame 11 shown in FIG. 1 completely surrounds (viz., fully encloses) viewing aperture 12, suitable frames may have a C-shape or other configuration having an open side or otherwise interrupted exterior edge that does not fully enclose the viewing aperture.

As also shown in FIG. 1, a total of 8 paint color representations 14a through 14j are disposed on frame 11. Greater or lesser numbers of paint color representations may be disposed on a single frame (for example, 3, 4, 5, 6, 7, 9, 10, 11 or 12 paint color representations), with 6 to 12 or 6 to 10 paint color representations generally providing a desirable range of colors or tints for color selection purposes. The paint color representations may be distributed evenly around the frame (for example, with the same or similar distances from the center of each paint color representation to the center of an adjacent paint color representation) or unevenly (for example, with dissimilar distances between centers).

The device shown in FIG. 1 has a single viewing aperture. Additional apertures (for example, 2, 3 or 4 apertures) may be employed if desired, and they need not all have the same shape. Normally however it will be best to employ only a single aperture in each device, and to employ several times (for example 4×, 6× or 8×) as many paint color representations as viewing apertures on each device. This may simplify use of the device and may help focus the user's attention on remotely located objects and surfaces and upon the displayed paint color representations rather than upon other (for example, non-colored) parts of the device.

For the device shown in FIG. 1, the viewing aperture has already been formed, and may be made for example using diecutting or other sheet stock manipulation techniques. If desired, the viewing aperture may however be formed using scoring, perforations or other hole-defining techniques, and removed completely (or pushed inwards or outwards and folded aside) at the time of use.

As shown in FIG. 2, paint color representations 14d through 14i have a discernible thickness, and project slightly from first major face 11a. This is generally desirable in order to convey a more realistic surface appearance and reflectivity, and may be brought about, for example, by applying the paint color representations using actual paint applied in such a manner as to form dried paint representations having uneven surfaces or non-symmetric shapes resembling manually applied daubs. As also shown in FIG. 2, the paint color representations have been disposed only on first major surface 11a. Paint color representations may however also be disposed on second major surface 11b, thereby enabling a user to turn frame 11 over and view paint color representations in for example additional colors, shades, tints or reflectivities, without having to set frame 11 aside.

FIG. 3 shows a user 32 holding a color selection device 10 like that shown in FIG. 1 by gripping frame 11 near the bottom edge using her outstretched hand 34, and viewing a remotely-located viewable area 35 through aperture 12. Viewable area 35 is shown outlined in phantom, and includes portions of wall 36, floor covering (e.g., carpet) 37, window frame 38 and base molding 39. The location and arrangement of paint color representations on frame 11 assists user 32 in making visual comparisons between the various paint color representations on frame 11 and the various viewable elements within viewable area 35. For example, a user's eyes may naturally tend to or otherwise be caused to move back and forth between one or more paint color representations and one or more remotely-located viewable elements of particular interest. Without intending to be bound by theory, it appears that by arranging several paint color representations around the viewing aperture, a user's eyes may first focus on the color of an object or surface behind the aperture and then reflexively or subconsciously travel to a nearby color representation on the frame and thereby “find” the best or most pleasing match or fit. A user may thereby be guided toward selection of more appropriate color choices and guided away from selection of less appropriate color choices.

The disclosed device may be used at a variety of viewing distances. The chosen distances may vary depending in part on factors such as the size and orientation of the object(s) or surface(s) to be viewed, the distance between multiple surfaces or objects to be viewed, and lighting conditions affecting the user and the object or surface to be viewed. Exemplary distances include, for example, about 0.3 to about 10 meters (about 1 to about 33 feet), about 0.9 to about 4.6 meters (about 3 to about 15 feet) or about 1.5 to about 3 meters (about 5 to about 10 feet), as measured from the frame to the object or surface to be viewed.

The user may easily alter the viewing or comparison experience. This may be done, for example, by moving closer to or further away from the viewable area, moving frame 11 further away from or closer to the user's eyes, rotating frame 11, or shifting frame 11 vertically or horizontally. The user thus can easily carry out quick manual adjustment of factors including the viewable area, the prominence of individual elements within that area, the interrelationship of individual elements with viewable paint color representations, and the colors, objects or surfaces being viewed. Selection of appropriate matching colors, appropriate complementary colors or both can often be accomplished without providing detailed or indeed any instruction to the user. Users typically quickly learn appropriate manipulative steps on their own through straightforward and instinctive hand, eye and other movements.

For the device shown in FIG. 1 through FIG. 3 the viewing aperture is centered in the frame and the frame has a constant width on all 4 sides. This is desirable but not required, and other viewing aperture orientations may be employed. For example, the frame may be provided with a widened portion, a projecting handle or other grip assist so that the user's hand will be spaced further away from the viewing aperture and thus be less apt to distract the user while making color comparisons.

FIG. 4 through FIG. 7 show additional exemplary embodiments of the disclosed color selection device. Device 40 in FIG. 4 includes frame 41 with oval-shaped viewing aperture 42, generally circular paint color representations 44a through 44h disposed on the front-facing major surface of frame 41 and distributed around viewing aperture 42, interiorly-disposed edge portion 46 defining the perimeter of viewing aperture 42, and exteriorly-disposed edge portions 48a through 48d defining the perimeter of frame 41.

Device 50 in FIG. 5 includes frame 51 with rectangular viewing aperture 52, generally rectangular paint color representations 54a through 54f disposed on the front-facing major surface of frame 51 and distributed around viewing aperture 52, interiorly-disposed edge portions 56a, 56b, 56c and 56d defining the perimeter of viewing aperture 52, and exteriorly-disposed edge portions 58a through 58d defining the perimeter of frame 51.

Device 60 in FIG. 6 includes frame 61 with rectangular viewing aperture 62, generally trapezoidal paint color representations 64a through 64f disposed on the front-facing major surface of frame 61 and distributed around viewing aperture 62, portions 66a, 66b, 66c and 66d defining the perimeter of viewing aperture 62, and exteriorly-disposed edge portions 68a through 68d defining the perimeter of frame 61. Unlike the paint color representations shown in the devices of FIG. 1 through FIG. 5 (in which the color representations are spaced apart, with visible frame portions between them), the paint color representations in the FIG. 6 device are contiguous to one another and do not have visible frame portions between them. Some users may prefer such an arrangement and may find it easier to carry out color selection without being distracted by visible portions of the device frame. Other users may prefer an arrangement in which the color representations are spaced apart from one another on the frame, as this may help the user concentrate on individual color representations and better filter out nearby color representations. For each of the embodiments shown in FIG. 1 through FIG. 6, the user's concentration is aided by placing each color representation near the viewing aperture, without interposing an intervening color representation whose presence could distract the user and which would need to be ignored in order to carry out a desired color comparison.

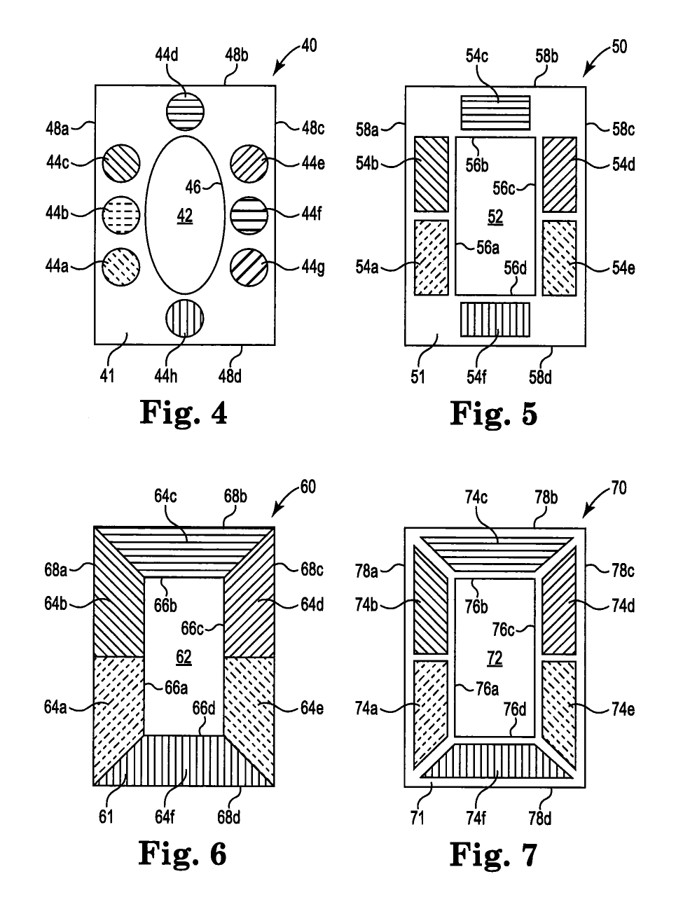

Device 70 in FIG. 7 includes frame 71 with rectangular viewing aperture 72, generally trapezoidal paint color representations 74a through 74f disposed on the front-facing major surface of frame 71 and distributed around viewing aperture 72, portions 76a, 76b, 76c and 76d defining the perimeter of viewing aperture 72, and exteriorly-disposed edge portions 78a through 78d defining the perimeter of frame 71.

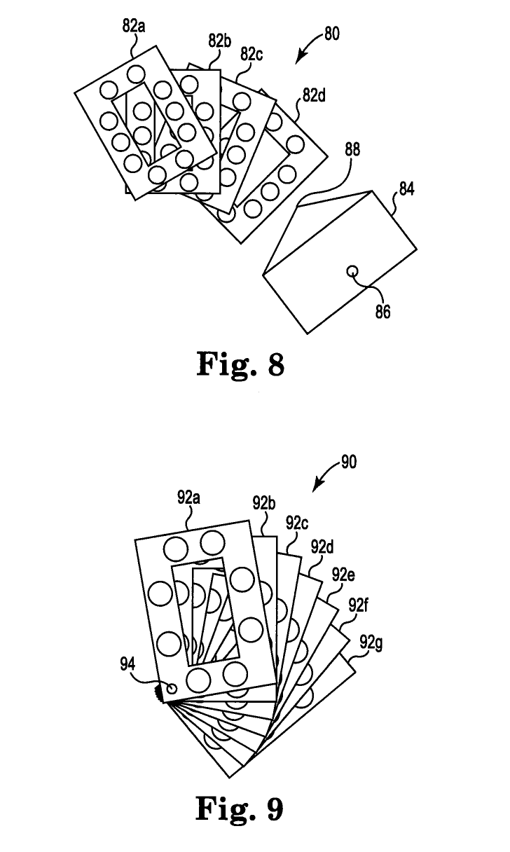

FIG. 8 shows an array 80 of color selection devices 82a through 82d like the device 10 shown in FIG. 1. Array 80 may be packaged in a variety of suitable packages, for example in a sleeve or jacket (not shown in FIG. 8), or in a container such as envelope 85 which may for example be secured in a closed position using button 86 and closure thread 88. Envelope 85 may also serve as a mailing envelope thereby facilitating delivery of array 82 to a user. The disclosed array will generally include paint color representations in different hues, tints, shades or reflectivities on each individual color selection device. The paint color representations may in the aggregate represent a wide range of similar or different (e.g. complementary) colors. The devices may for example individually or in the aggregate depict an array of pastel tints having different hues, an array of shades (for example an array of gray shades), an array of complementary colors, an array of primary colors, an array of tints, or an array having a plurality of surface reflectivities (for example matte, semi gloss and gloss surface reflectivities). If desired an individual paint color representation may appear more than once on a frame or more than once in an array. The disclosed arrays may include more than or less than the four devices shown in FIG. 8 and may for example include 2, 3, 5, 6, 7, 8, 9, 10 or even more such devices.

To use the arrays shown in FIG. 8, a user may for example hold most or all of the devices in a first free hand (or set them on a suitable nearby surface such as a table or fireplace mantle) and then use a second free hand to select one or more devices and view remote objects or surfaces. Additional or other devices can readily be held in the second free hand, be shifted to the first free hand, propped up on a suitable support or otherwise positioned in order to carry out further viewing and make further color comparisons.

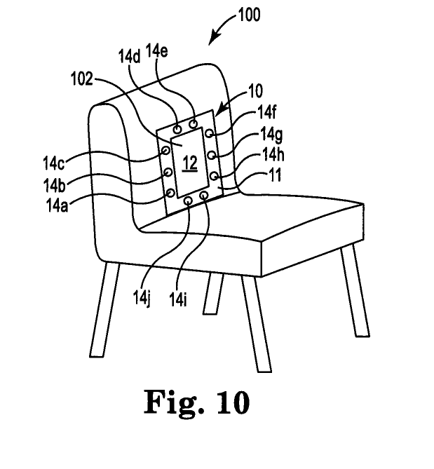

FIG. 9 shows an array 90 of color selection devices 92a through 92g fastened together by pivot pin 94. Array 90 provides a handheld “fan deck” similar in some respects to the fan deck color cards currently available from paint manufacturers and merchants, but with the added benefit of a viewing aperture in each fan deck card around which is distributed a plurality of distinct paint or color representations and through which a user can view remote objects and surfaces. Some users may prefer a fan deck configuration like that shown in FIG. 9, while other users may prefer separated color selection devices like those shown in FIG. 8. Both types of users may be accommodated by making pivot pin 94 easily detachable or otherwise openable so that a user may collate and fan or separate and individually employ the disclosed devices as desired.

A variety of materials may be used to prepare the device frames. Exemplary materials include paper, card stock, corrugated cardboard, plastic film, plastic sheet, metal and wood. The frames may be opaque, translucent or transparent, and may be provided in white or in a variety of colors including pastels, grays and black. The frames may also have a variety of surface textures, including smooth, roughened or grained surfaces, and may have a variety of surface reflectivities including matte, semi gloss and gloss.

The paint or stain color representations may be applied using a variety of methods that will be familiar to persons having ordinary skill in the art, including brush, dauber, spray or roller application of actual paints or stains. Doing so will in general provide the most accurate color and sheen representation. However, if desired the paint or stain color representations may be made using simulations of paints or stains applied using printing or other coating techniques, including lithography, screen printing, 4-color offset, thermal transfer, dye sublimation and inkjet. The paint color representations may be applied at a variety of wet or dry film thicknesses. The initial or eventual dry film thickness may for example be about 13 to about 260 μm (about 0.5 to about 10 mil) or about 25 to about 150 μm (about 1 to about 6 mil).

Having thus described preferred embodiments of the present invention, those of skill in the art will readily appreciate that the present teachings may be applied to yet other embodiments within the scope of the attached claims. The complete disclosures of any patents, patent documents, or other publications referred to herein are incorporated by reference as if individually set forth.

We claim:

1. A paint or stain color selection device comprising a frame sized for arms-length handheld use, the frame having first and second major surfaces, at least one interiorly-disposed edge portion, and at least one exteriorly-disposed edge portion; the frame at least partially surrounding a viewing aperture defined by the interiorly-disposed edge portion(s); and the frame having disposed on at least one of the major surfaces and distributed around the viewing aperture a plurality of distinct paint or stain color representations having surface areas smaller than the cross-sectional area defined by the viewing aperture.

2. A device according to claim 1 wherein the frame is rectangular.

3. A device according to claim 1 having a plurality of viewing apertures and more paint or stain color representations than viewing apertures.

4. A device according to claim 1 having a single viewing aperture.

5. A device according to claim 4 wherein the frame completely surrounds the viewing aperture.

6. A device according to claim 4 wherein the viewing aperture is centered in the frame.

7. A device according to claim 4 wherein the viewing aperture is rectangular.

8. A device according to claim 4 wherein the viewing aperture is circular.

9. A device according to claim 1 wherein the frame is white.

10. A device according to claim 1 wherein the frame is transparent.

11. A device according to claim 1 wherein each paint or stain color representation is different from the remaining paint or stain color representations.

12. A device according to claim 1 wherein the paint or stain color representations include color identification indicia.

13. A device according to claim 1 wherein each paint or stain color representation includes a color identification indicium.

14. A device according to claim 1 wherein the paint or stain color representations are printed.

15. A device according to claim 1 comprising paint color representations.

16. A device according to claim 15 wherein the paint color representations are actual paint.

17. A device according to claim 15 wherein the paint color representations are brush- or dauber-applied paint.

18. A device according to claim 15 wherein the paint color representations have uneven surfaces or non-symmetric shapes resembling manually applied daubs.

19. A device according to claim 15 wherein the paint color representations are manually applied daubs.

20. A device according to claim 15 wherein the paint color representations are spray-applied paint.

21. A device according to claim 15 wherein the paint color representations comprise an array of pastel tints.

22. A device according to claim 15 wherein the paint color representations comprise an array of gray shades.

23. A device according to claim 15 wherein the paint color representations comprise an array of complementary colors.

24. A device according to claim 15 wherein the paint color representations comprise an array of primary colors.

25. A device according to claim 15 wherein the paint color representations depict a base paint tinted with an array of tints.

26. A device according to claim 1 comprising stain color representations.

27. A device according to claim 1 wherein the paint or stain color representations have a plurality of surface reflectivities.

28. An array of devices according to claim 1 collectively comprising paint or stain color representations in a plurality of hues, shades, complementary colors, primary colors, tints, surface reflectivities or mixture thereof.

29. A method for making a paint or stain color selection device, the method comprising:
a) providing a frame sized for arms-length handheld use, the frame having first and second major surfaces and at least one exteriorly-disposed edge portion; the frame at least partially surrounding an actual or openable viewing aperture; and
b) applying to a major surface of the frame a plurality of distinct paint or stain color representations having surface areas smaller than the cross-sectional area defined by the viewing aperture, the paint or stain color representations being distributed around the viewing aperture.

30. A method for selecting a paint or stain, the method comprising:
a) providing a paint or stain color selection device comprising a frame sized for arms-length handheld use, the frame having first and second major surfaces, at least one interiorly-disposed edge portion, and at least one exteriorly-disposed edge portion; the frame at least partially surrounding a viewing aperture defined by the interiorly-disposed edge portion(s); and the frame having disposed on at least one of the major surfaces and distributed around the viewing aperture a plurality of distinct paint or stain color representations having surface areas smaller than the cross-sectional area defined by the viewing aperture;
b) selecting a viewable object or surface for comparison to the paint or stain color representations;
c) viewing the object or surface through the viewing aperture while visually comparing the object or surface to one or more of the paint or stain color representations.
